(19) United States
(12) Patent Application Publication
(10) Pub. No.: US 2017/0035246 A1
(43) Pub. Date: Feb. 9, 2017

(54) Toaster Aid

(71) Applicant: Esmail Roostaie, Austin, TX (US)

(72) Inventor: Esmail Roostaie, Austin, TX (US)

(21) Appl. No.: 14/820,546

(22) Filed: Aug. 6, 2015

(51) Int. Cl. A47J 37/08

(52) U.S. Cl. CPC A47J 37/0885

(57) ABSTRACT

A device is provided for toasting food products comprising a rectangular-shaped metallic mesh body configured to received and hold a food product during toasting in a toaster. The top of the metallic mesh body is open to receive the food product, and the bottom of the metallic mesh body is a solid metallic platform that prevents pieces of the food product from falling into the interior of the toaster. Extending substantially vertically from the top of the metallic mesh body is a plastic-coated handle for safely manipulating the device. When fully inserted into a toaster slot, the top of the metallic mesh body is flush with the top of the toaster slot, and the handle is outside the toaster slot.

### BACKGROUND OF THE INVENTION

1. Field of the Invention

Embodiments of the present invention generally relate to allow users to better toast flatbreads, tortillas, pitas, and other thin breads in their own conventional toaster.

2. Description of the Related Art

Current conventional toasters do not work well with thinner breads; they are typically used to toast Western-style sliced bread. As a result of the current technology, users are forced to fold, crinkle, or otherwise inefficiently toast their bread. The net result of this is often the bread does not toast evenly, comes out overly cold or overly burnt, or even sometimes results in dangerous situations such as kitchen fires, electric shock, and physical skin burns when removing the toast that has sunk in too far into the toaster slot. There are numerous reports of household fires being caused by toasters as a result of uneven burning and/or crumbs that get stuck at the bottom of the devices.

Moreover, there are on the market separate standalone flatbread toasters that are their own small appliance. Due to increased cost and limited kitchen space, most consumers do not find it prudent to purchase these devices. Thus, there also is a need for a heating and/or toasting accessory for efficient and cost-effective use with a typical household conventional toaster, thereby not requiring the purchase of an entirely separate standalone device.

### SUMMARY OF THE INVENTION

An apparatus for advantageously toasting thin breads and other food products within conventional toaster slots is provided. The device comprises a rectangular-shaped metallic mesh body configured to received and hold a food product during toasting in a toaster. The top of the metallic mesh body is open to receive the food product, and the bottom of the metallic mesh body is a solid metallic platform that prevents pieces of the food product from falling into the interior of the toaster. Extending substantially vertically from the top of the metallic mesh body is a plastic-coated handle for safely manipulating the device. When fully inserted into a toaster slot, the top of the metallic mesh body is flush with the top of the toaster slot, and the handle is outside the toaster slot.

### BRIEF DESCRIPTION OF THE DRAWINGS

FIG. 1 is a schematic side view of an embodiment of a pita and tortilla toast aid device.

FIG. 2 is a schematic side view of an embodiment of a pita and tortilla toast aid device being partially inserted into a conventional household toaster with a tortilla inside the accessory.

### DETAILED DESCRIPTION OF PREFERRED EMBODIMENTS

Embodiments of the present invention provide an accessory to be inserted into an existing conventional household toaster for the purpose of safely and efficiently toasting pitas, tortillas, flatbreads, and other thin breads, resulting in evenly-warmed thin toast in the much the same manner that one would toast Western-style sliced bread that conventional household toasters are typically used for. The present invention not only allows a more ideal fitting space for the thin bread (so as to prevent it from falling over to one side or having to be folded) but also provides a safeguard platform on the bottom to catch crumbs that may otherwise fall into the bottom of the toaster. Additionally, the heat-resistant handle attached to the device allows for easy removal of the thin bread.

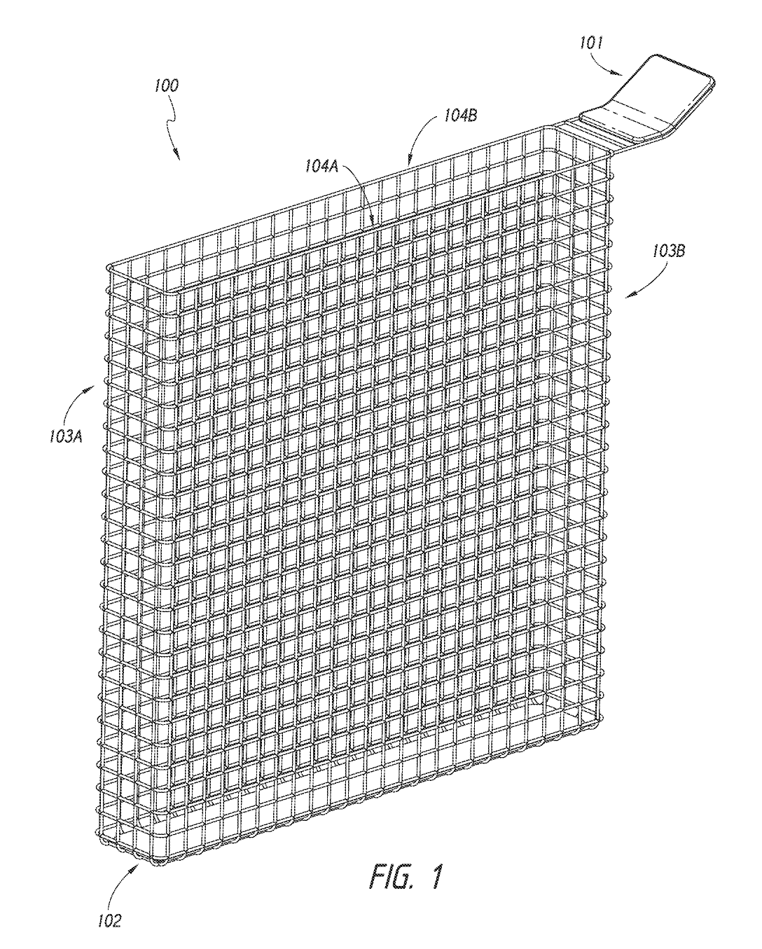

A primary embodiment is described with respect to FIG. 1, which schematically illustrates a side view of the toast aid accessory 100. In the illustrated embodiment, the toast aid accessory 100 comprises two household-safe metallic sidings 103A and 103B with width that is slightly larger than a typical flatbread attached via soldering or other method to two other wider household-safe metallic sidings 104A and 104B, the result being a rectangular-shaped metallic crate that holds a typical flatbread upright, in relatively snug fashion. The metallic sidings can, for example, be made of steel, aluminum, copper, iron or other like materials. Moreover, the sidings can alternatively be made of a metal-alternative as would be understood by one of skill in the art, as long as the metal-alternative conducts heat and is not a safety hazard. This metallic mesh body can have rectangular or curved sides such that it can appear as a thin box or a pocket.

At the bottom of the metallic crate there is a solid household-safe metallic platform 102 that prevents breadcrumbs from falling into the interior of the household toaster. Alongside 103B, attached vertically at the top of the siding is a plastic-covered handle 101 that juts out of the device 100. The handle 101 is covered in plastic or similar material so that when the toast is completed and the toaster aid is popped out of the household toaster, the user may safely grab and lift the aid out of the toaster and thereby remove the thin bread.

The metallic sidings 104A and 104B may, in alternative embodiments, be narrower or wider depending on the size of the toaster it is meant to go into as well as the size of the various flatbreads it is meant to contain. The standard tortilla/flatbread size would require the embodiment to have a height of approximately 6 to 7 inches, a width of approximately 5 to 6 inches, and a thickness of approximately 1 to 1.5 inches. An alternative embodiment—used to accommodate a larger size tortilla/flatbread—would have a height of approximately 6 to 7 inches, a width of approximately 10 to 11 inches, and a thickness of approximately 1 to 1.5 inches.

Thus, as shown, the device has a metallic mesh body with four sides, a solid (non-mesh) bottom portion, and a top portion opposite the bottom portion. The side portions connect to form a rectangular body that is configured to hold the food product during toasting, which is inserted into the device via the opening at the top portion.

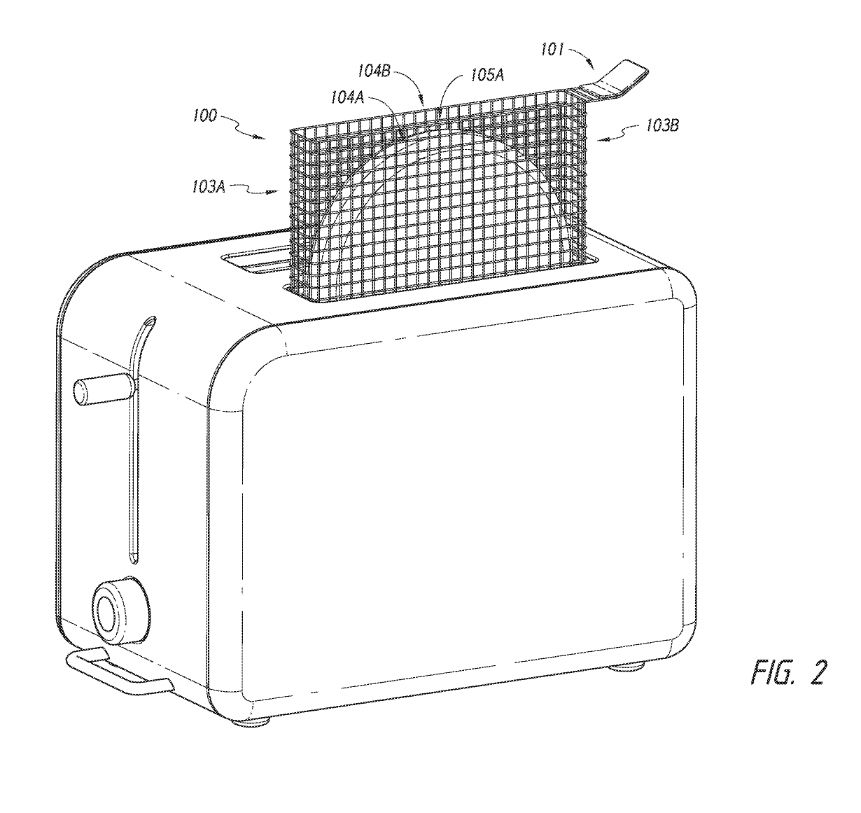

FIG. 2 illustrates a schematic side view of an embodiment 200 being slotted into a conventional household toaster. Generally, this embodiment presents a metal-based container that is the size of internal slots of a conventional toaster that easily slides into a conventional toaster, such that there is a solid platform formed at the bottom of the container to hold any and all crumbs, and a vertical plastic-covered handle that is attached to the container alongside its thinner end for easy removal of toasted bread.

The embodiment 200 is, for purposes of the illustration, suspended halfway outside the conventional household toaster so as to be visible. Once the tortilla or flat bread 205 is dropped into the toaster aid 200, the user grabs the handle 201 and slides the aid 200 down into the conventional household toaster. The resulting aid 200 will be flush with the top of the internal toaster slots, with the handle 201 resting above and out from the toaster slot. The handle should be heat resistant and cool to the touch even when the device is being heated within a toaster. Thus, in a preferred embodiment, the handle can comprise a metal core that is coated with a layer of heat-resistant material such as a polymer (e.g. silicone rubber). An alternative embodiment of the handle 201 may be presented to jut out of the wider horizontal ends of the toaster aid on both sides to resemble the handles of a handbag.

Although illustrative embodiments have been described herein with reference to the accompanying drawings, it is to be understood that the present invention is not limited to those precise embodiments, and that various other changes and modifications may be affected therein by one skilled in the art without departing from the scope or spirit of the invention. All such changes and modifications are intended to be included within the scope of the invention as defined by the appended claims.

1. A device for holding a food product during toasting comprising:
a metallic mesh body having four side portions, a bottom portion, and a top portion;
wherein the side portions are connected with each other to form a rectangular body, the side portions further comprising a pair of opposing larger side portions and a pair of opposing smaller side portions;
wherein the bottom portion comprises a metallic platform connected to said side portions and configured to support the food product;
an opening opposite the bottom portion, said opening configured to receive the food product;
wherein the opening has a height, a width, and a thickness;
wherein the opening thickness is defined by the distance between the opposing larger side portions;
a handle extending from the top portion of the metallic mesh body, said handle allowing for the movement and manipulation of the device; and
wherein the length of the handle is no greater than twice the opening thickness.

2. The device of claim 1 wherein the device is configured to fit within a slot of a conventional toaster, wherein upon insertion of the device into the toaster slot, the top portion of the metallic mesh body is flush with the top of the toaster slot and the handle of device is outside the toaster slot.

3. The device of claim 1 wherein the handle comprises a metal member coated with a heat-resistant polymer.

4. The device of claim 1 wherein the handle comprises a metal member coated with a silicone rubber.

5. A device for holding a food product during toasting comprising:
a metallic mesh body having a top portion and a bottom portion;
a metallic platform located within the bottom portion of the mesh body, said metallic platform being connected to the mesh body and configured to support the food product;
an opening at the top portion of the mesh body, said opening being positioned opposite to the metallic platform and configured to receive the food product into the mesh body;
wherein the opening has a length and a width, the length being greater than the width;
a handle extending from the top portion of the metallic mesh body, said handle allowing for the movement and manipulation of the device; and
wherein the length of the handle is no greater than twice the width of the opening.

6. The device of claim 1 wherein the device is configured to fit within a slot of a conventional toaster, wherein upon insertion of the device into the toaster slot, the top portion of the metallic mesh body is flush with the top of the toaster slot and the handle of device is outside the toaster slot.

7. The device of claim 5 wherein the handle comprises a metal member coated with a heat-resistant polymer.

8. The device of claim 5 wherein the handle comprises a metal member coated with a silicone rubber.

9. The device of claim 1 wherein the handle is attached to, and extends from, the larger side portion.

10. The device of claim 5 wherein the handle is attached to, and extends from, the center of the top portion of the metallic mesh body.
